(19) United States
(12) Patent Application Publication
(10) Pub. No.: US 2012/0066513 A1
(43) Pub. Date: Mar. 15, 2012

(54) METHOD AND APPARATUS FOR AUTHENTICATING A NON-VOLATILE MEMORY DEVICE

(75) Inventors: Bo-Gyeong KANG, Suwon-si (KR); Byung-Rae LEE, Seoul (KR)

(73) Assignee: Samsung Electronics Co., Ltd., Suwon-si (KR)

(21) Appl. No.: 13/230,431

(22) Filed: Sep. 12, 2011

(30) Foreign Application Priority Data
Sep. 10, 2010 (KR) 10-2010-0088941
Oct. 11, 2010 (KR) 10-2010-0099009
Sep. 2, 2011 (KR) 10-2011-0089167

(51) Int. Cl. G06F 21/00; G06F 12/14

(52) U.S. Cl. 713/189; 726/2

(57) ABSTRACT

A method and an apparatus for authenticating a non-volatile memory device are provided. The method includes sending, to the memory device, a request for an Enhanced Media Identification (EMID) for identifying the memory device, by an EMID decoder for authenticating the memory device; receiving the requested EMID changed by a preset calculation of the EMID with an optional value from the memory device; and restoring the EMID by decoding the received changed EMID.

### PRIORITY

This application claims priority under 35 U.S.C. §119(a) to Korean Patent Applications filed in the Korean Intellectual Property Office on Sep. 10, 2010, Oct. 11, 2010 and Sep. 2, 2011, and assigned Serial Nos. 10-2010-0088941, 10-2010-0099009 and 10-2011-0089167, respectively, the entire contents of which are incorporated herein by reference.

### BACKGROUND OF THE INVENTION

1. Field of the Invention

The present invention relates generally authentication of a memory device, and more particularly, to a method and an apparatus for authenticating a non-volatile memory device.

2. Description of the Related Art

With the use of various technologies, such as include Digital Rights Management (DRM) technology, copy protection technology, etc., to protect content, there has been a need for a technology for authenticating a storage device, including a Non-Volatile Memory (NVM) devices such as a Solid State Disk (SSD) and a flash memory card for storing this protected content. Namely, there has been a need for a technology for verifying the suitability (from a HardWare (H/W) perspective) of a storage device, as well as a technology for encrypting content itself.

Technologies such as DRM, Content Protection for Recordable Media (CPRM) for a Secure Digital (SD) card, and Advanced Access Content System (AACS) for a Blu-Ray® disk, provide a method for authenticating a device by using a Public Key Infrastructure (PKI) or another cryptographic technology. However, such authentication methods may be vulnerable to various forms of attacks, such as an attacks performed by cloning a storage device itself, authenticating an inappropriate storage medium by a legitimate player device, etc., for example.

In a method for authenticating a device, which is proposed by the technologies including the CPRM technology for an SD card, the AACS technology for a Blue-ray disk, etc., an identifier is stored at a location designated in a read-only area at the time of manufacturing a storage medium. Then, a cryptographic scheme applied to the storage medium is used for device authentication, content protection, etc. In this regard, the above authentication method has a problem such that an illegal hardware manufacturer can easily clone multiple authenticated devices.

FIG. 1 is a block diagram illustrating an example of a conventional operation for illegitimately authenticating a storage medium.

Referring to FIG. 1, during an attack, security information and content stored in an appropriate memory card 110 are recorded (see reference numeral 130) in a clone card 120 and then data, such as firmware, etc., of a controller are manipulated, thereby successfully authenticating (see reference numeral 150) the clone card 120 by a legitimate player 140. Such an attack enables the distribution of a card that stores illegal content, and thus greatly damages content providers or terminal manufacturers, until the card itself is discarded afterwards.

### SUMMARY OF THE INVENTION

Accordingly, an aspect of the present invention is to solve the above-mentioned problems, and to provide a method and an apparatus for authenticating a non-volatile memory device, which are robust against an attack pretending to be a storage medium having legitimate content.

In accordance with an aspect of the present invention, a method for authenticating a non-volatile memory device is provided. The method includes sending, to the memory device, a request for an Enhanced Media Identification (EMID) for identifying the memory device, by an EMID decoder for authenticating the memory device; receiving the requested EMID changed by a preset calculation of the EMID with an optional value from the memory device; and restoring the EMID by decoding the received changed EMID.

In accordance with another aspect of the present invention, an EMID decoder for authenticating a non-volatile memory device is provided. The EMID decoder includes a medium authenticator for sending, to the memory device, a request for an EMID for identifying the memory device, receiving the requested EMID changed by a preset calculation of the EMID with an optional value, and delivering the received changed EMID to an EMID restoration unit; and the EMID restoration unit for restoring the EMID by decoding the received changed EMID.

### BRIEF DESCRIPTION OF THE DRAWINGS

The above and other features, aspects, and advantages of the present invention will be more apparent from the following detailed description taken in conjunction with the accompanying drawings, in which:

FIG. 1 is a block diagram illustrating an example of a conventional operation for illegitimately authenticating a storage medium;

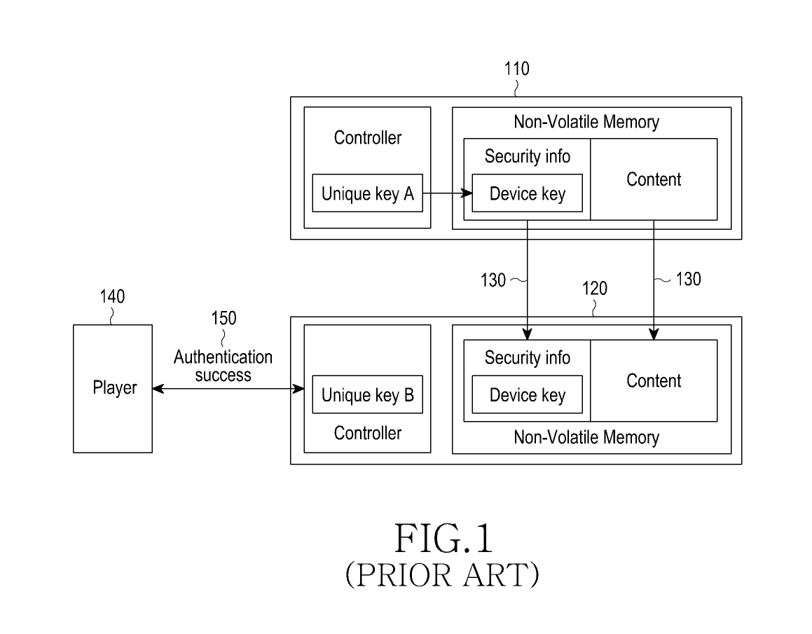

FIG. 2 is a block diagram illustrating an example of a technology model for an operation for authenticating a storage medium according to an embodiment of the present invention;

FIG. 3 is a block diagram illustrating the configuration of an authentication system when an operation for authenticating a storage device is performed, according to an embodiment of the present invention;

FIG. 4 is a block diagram illustrating a configuration when an operation for storing and reproducing content is performed, according to an embodiment of the present invention;

FIG. 5 is a block diagram illustrating an operation for receiving changed Enhanced Media Identifications (EMIDs) multiple times, when an operation for storing and reproducing content is performed, according to an embodiment of the present invention;

FIG. 6 is a block diagram illustrating the configuration of an apparatus for authenticating a storage device according to an embodiment of the present invention;

FIG. 7 is a flowchart illustrating a method for recording content in a storage device according to an embodiment of the present invention; and

FIG. 8 is a flowchart illustrating a method for reproducing content recorded in a storage device according to an embodiment of the present invention.

### DETAILED DESCRIPTION OF EMBODIMENTS OF THE PRESENT INVENTION

Hereinafter, an apparatus and an operation method thereof according to embodiments of the present invention are described in detail with reference to the accompanying drawings. The following description includes various specific details to provide a more general understanding of the present invention. Therefore, it will be apparent to a person having ordinary knowledge in the technical field of the present invention that variations and modifications may be made in the specific details without departing from the scope of the present invention. Also, detailed descriptions of publicly-known techniques related to the present invention will be omitted when detailed descriptions of such techniques may unnecessarily obscure the subject matter of the present invention.

According to embodiments of the present invention, a method and an apparatus for authenticating a non-volatile storage medium is provided. To this end, according to embodiments of the present invention, an Enhanced Media Identification (EMID) corresponding to an encoded identifier is inserted into a particular area of the storage medium. Then an EMID, for which noise has been generated, is generated by a means included in the storage medium for generating noise for an EMID and changing the EMID. The EMID, for which the noise has been generated, is delivered to a recording device or a storage device, and the recording device or the storage device performs authentication by decoding the EMID for which the noise has been generated.

In order to perform a series of authentication processes as described above, when a storage medium, a recording device, and a reproduction device are manufactured, consultation may be arranged, in advance, on a means for generating an EMID or a means for decoding an EMID.

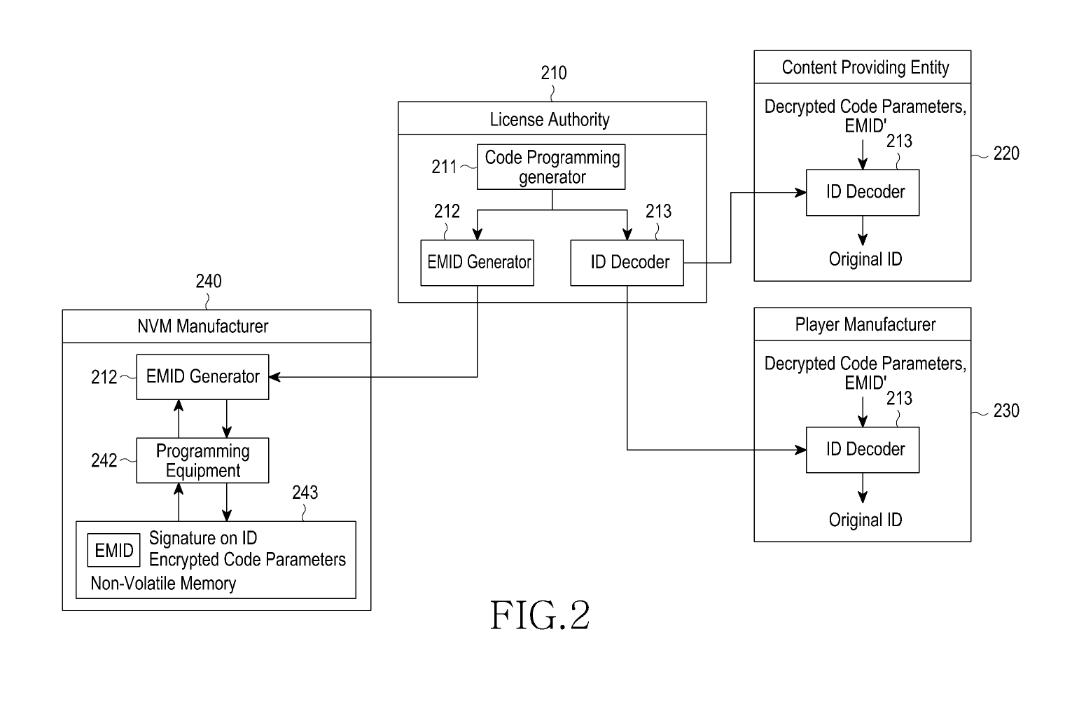

FIG. 2 is a block diagram illustrating an example of a technology model for authenticating a storage medium according to an embodiment of the present invention.

Referring to FIG. 2, first, a license authority 210 for determining a scheme for authenticating a storage device determines an EMID generator 212 for encoding an ID, an ID decoder 213 for decoding an EMID, and a code parameter generator 211 for generating a code parameter determining a decoding scheme.

A content providing entity 220, such as a kiosk and/or a content aggregator, which records content in a storage device and then provides the recorded content, may receive the ID decoder 213 determined by the license authority 210, and then use a function for restoring a decrypted code parameter and a changed EMID (i.e. an EMID including noise) to an original ID. Also, the content providing entity 220 authenticates a physical identifier of the storage device by using this function, and then records content in the storage device by binding the legitimate content to the physical identifier of the storage device.

A player manufacturer 230, which manufactures a player for reproducing the content recorded in the storage device, may also receive the ID decoder 213 determined by the license authority 210 and then restore a decrypted code parameter and a changed EMID (i.e. an EMID including noise) to an original ID. A player manufacturer 230 manufactures a reproduction device including this function. The content reproduction device manufactured as described above may authenticate the physical identifier of the storage device, and then reproduce content recorded in a legitimate storage device through an authentication method according to the present invention.

An NVM manufacturer 240, which manufactures a storage device, receives the EMID generator 212 determined by the license authority 210. When manufacturing a storage device, the NVM manufacturer 240 generates an EMID by using the EMID generator 212, records the generated EMID in a particular area of the storage device by inserting the EMID into the particular area thereof so that the EMID generator 212 can record the EMID only once in the particular area of the storage device through a programming equipment 242, and manufactures the storage device including a signature on the ID and encrypted code parameters. The EMID is initially recorded only once in a particular area of the storage device. Therefore, subsequent writing to the relevant area is limited (i.e. read-only), and subsequent reading from the relevant area may be performed only through a special interface.

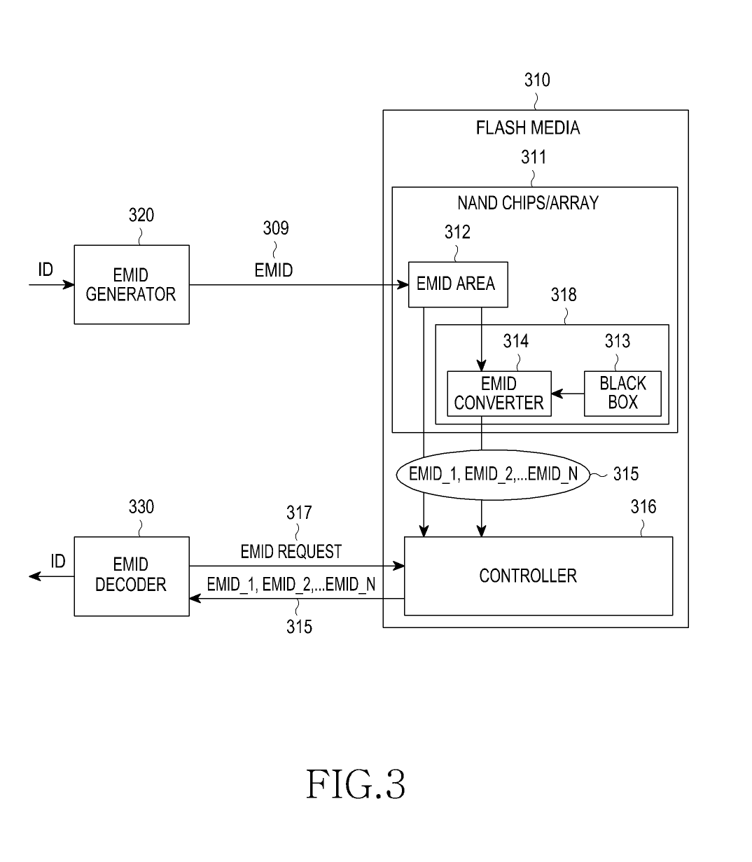

FIG. 3 is a block diagram illustrating a configuration of an authentication system when an operation for authenticating a storage device is performed, according to an embodiment of the present invention.

Referring to FIG. 3, a storage device 310 according to an embodiment of the present invention may be a storage medium such as a flash memory.

The storage device 310 includes a controller 316 for controlling input/output and read/write operations of the storage device, and a non-volatile memory area 311, such as a NAND Flash, for storing data. The non-volatile memory area 311 includes an optionally designated EMID area 312 for storing an EMID, and an EMID encoder 318 for generating noise for an EMID and changing the EMID.

The EMID area 312 includes a type 1 area and a type 2 area. The type 1 area, which is an area used only in the non-volatile memory area 311, read and write operations by either a host device, the controller 316 or the like, which records content in a storage device or reproduces content recorded in the storage device, are prevented after the storage device completes a process thereof. The type 2 area is an area that a host device, such as a recording device or a reproduction device, may read by a read command of a storage device 310.

The EMID encoder 318 includes an EMID converter 314 for performing an EMID conversion operation and a black box 313 for generating a random error used when the EMID converter 314 performs an EMID conversion operation. The EMID encoder 318 changes an EMID value through a preset calculation of the EMID value with a random value (i.e. a random error) generated by the black box 313, unique information of the non-volatile memory area 311 included in the type 1 area of the EMID area 312, and a value for an EMID encoding operation previously received from the host device.

The black box 313 may include particular seed information used when the EMID converter 314 performs an EMID conversion operation, or may randomly generate seed information through a particular added circuit. When an element generated by the authentication system is used to generate seed information, the seed information may be dynamically generated.

An EMID generator 320 generates an EMID by encoding a value selected as an ID.

An EMID decoder 330 receives, as input, at least one EMID 315, for which noise has been generated, and then restores the value of the EMID 315 to the original EMID value.

When extracting an EMID corresponding to a physical identifier inserted into the EMID area 312, the EMID encoder 318 generates noise. The EMID encoder 318 may be implemented by using a random number generator, a scrambler, etc. The EMID encoder 318 generates multiple EMIDs for which noise has been generated.

Meanwhile, when content is recorded in the storage medium or content recorded in the storage medium is reproduced, the controller 316 delivers the EMIDs 315, for which noise has been generated by the EMID encoder 318, to the EMID decoder 330 of the relevant device, in response to an EMID request 317 of a recording device or a reproduction device.

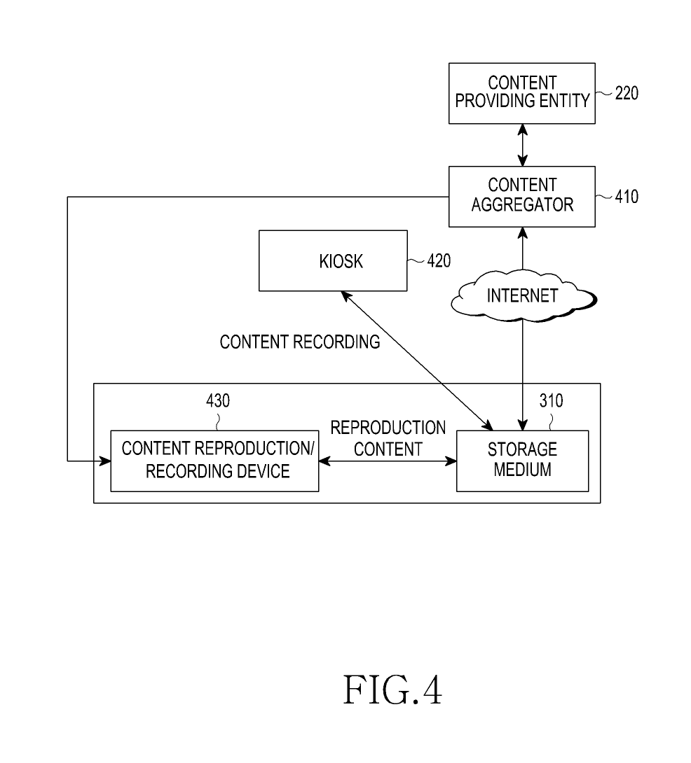

FIG. 4 is a block diagram illustrating a configuration of an authentication system when an operation for recording and reproducing content is performed, according to an embodiment of the present invention.

Referring to FIG. 4, a content aggregator 410 collects content information from the content providing entity 220 for the reuse or sale of content. The content aggregator 410 or a kiosk 420 records content in the storage medium (i.e. a storage device) 310.

The content recorded in the storage medium 310, which is manufactured as described above, is reproduced by a content reproduction or recording device 430. When content is recorded in the storage device or content recorded in the storage device is reproduced, a method for authenticating a storage device as described above is used.

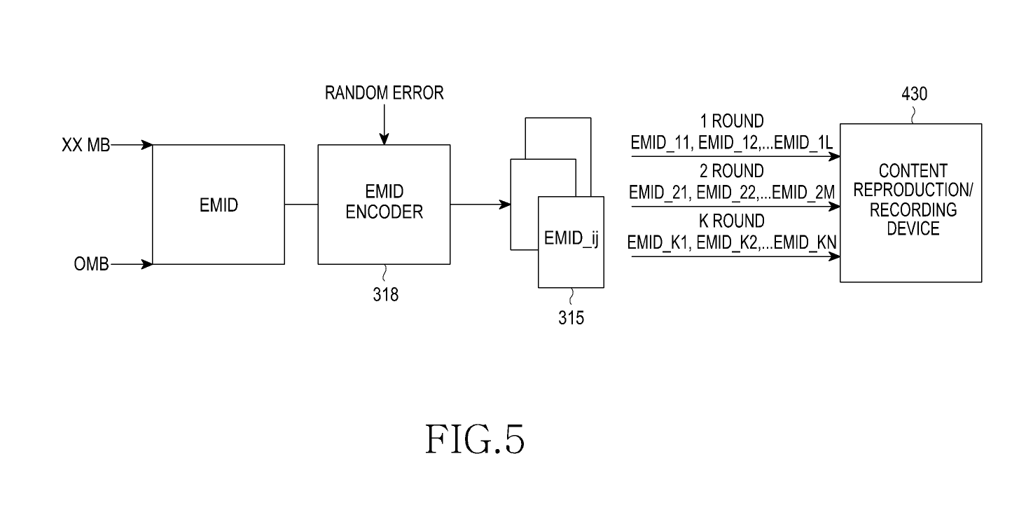

FIG. 5 is a block diagram illustrating an operation for receiving changed EMIDs multiple times, when an operation for storing and reproducing content is performed, according to an embodiment of the present invention.

Referring to FIG. 5, an EMID recorded in a particular location of the storage device is converted to multiple EMIDs 315, which are obtained in such a manner that an EMID recorded in the particular location of the storage device first goes through the EMID encoder 318 and then noise is generated for the EMID by the EMID encoder 318, at the request of the content reproduction or recording device 430. As illustrated in FIG. 5, in the method for authenticating the storage device, a process for generating changed EMIDs is repeatedly performed according to the features of the present invention. Herein, a process for generating multiple changed EMIDs once, by the EMID encoder 318, is referred to as a single round. During this process, the content reproduction or recording device 430 repeatedly requests changed EMIDs from the storage device, and the EMID encoder 318 generates changed EMIDs of a corresponding round in response to each request (i.e. in each round) and then transmits the generated changed EMIDs to the content reproduction or recording device 430.

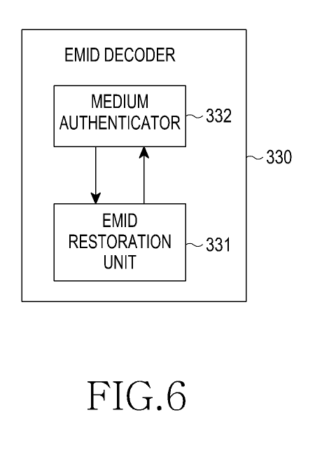

FIG. 6 is a block diagram illustrating the configuration of an apparatus for authenticating a storage device according to an embodiment of the present invention.

Referring to FIG. 6, an EMID decoder 330 for authenticating a storage device according to an embodiment of the present invention includes a medium authenticator 332 and an EMID restoration unit 331.

After providing the EMID restoration unit 331 with multiple changed EMIDs received from the storage device 310, the medium authenticator 332 receives, as input, an EMID that is output from the EMID restoration unit 331, and then cryptographically verifies the received EMID, thereby determining whether the storage device 310 is legitimate.

The EMID decoder 330 sends a request to the storage device 310 for a signature corresponding to the ID and then receives the requested signature. The medium authenticator 332 authenticates the storage device 310 by using a restored ID and the received signature.

The medium authenticator 332 sends a request to the storage device 310 for multiple changed EMIDs and receives the requested changed EMIDs from the storage device 310, delivers the received changed EMIDs to the EMID restoration unit 331, and verifies the restored EMID by using the signature received from the storage device 310.

The EMID restoration unit 331 restores the received encoded ID information to the original EMID by decoding the received encoded ID information.

According to the present example, the changed EMIDs, which the EMID decoder 330 has received from the storage device 310 in response to the request, may be multiple EMIDs generated in a manner that reflects a random error.

When the EMID decoder 330 records content in the storage device 310, the medium authenticator 332 generates a BoundEncryptionKey of the content by binding the content to the restored and verified EMID. The medium authenticator 332 encrypts the content to be recorded, by using the BoundEncryptionKey.

By contrast, when the EMID decoder 330 reproduces content recorded in the storage device 310, the medium authenticator 332 generates a BoundEncryptionKey by using both the restored and verified EMID and an encryption key of the content. The medium authenticator 332 decrypts the content by using the BoundEncryptionKey.

The medium authenticator 332 repeatedly sends a request to the storage device 310 for changed EMIDs. At each request, the medium authenticator 332 performs the operations of receiving changed EMIDs, restoring the received changed EMIDs to the original EMID, and verifying the restored EMID.

The medium authenticator 332 sends a request to the storage device 310 for a signature corresponding to the ID and parameter information for EMID decoding, and receives the requested signature and parameter information from the storage device. The EMID restoration unit 331 decodes the EMIDs, for which noise has been generated, by using the received parameter information, and then restores the changed EMIDs to the original EMID.

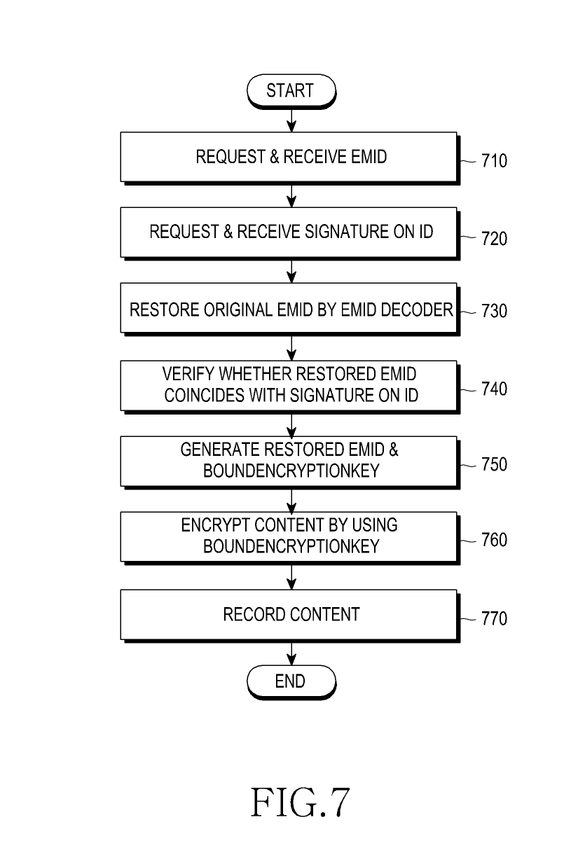

FIG. 7 is a flowchart illustrating a method for recording content in a storage device according to an embodiment of the present invention.

Referring to FIG. 7, in step 710, a recording device 430 (i.e. an authentication apparatus 330) sends a request to the storage device 310 for changed EMIDs, and receives the requested changed EMIDs from the storage device 310. At this time, the received changed EMIDs have multiple values (e.g., EMID_1, EMID_2, . . . , and EMID_N), respectively, obtained in such a manner that a value stored in the EMID area 312 of the storage device 310 first goes through the EMID encoder 318 and then noise is generated for the value by the EMID encoder 318.

In step 720, the recording device 430 sends a request to the storage device 310 for a signature on the ID, an encrypted code parameter, etc., which are necessary to verify the storage device 310, and then receives the requested signature, encrypted code parameter, etc., from the storage device 310.

In step 730, the recording device 430 provides the multiple values received in step 710 to the EMID decoder 330. The EMID decoder 330 applies a decoding process to the multiple received values (EMID_i 1≦i≦N), and then extracts the original EMID (ID_i for 1≦i≦N).

In the present example, the recording device 330 may restore the original EMID from the multiple values provided in one round.

In step 740, a typical RSA cryptosystem verifies whether the extracted EMID (ID_i for 1≦i≦N) coincides with a signature on the ID, as defined in Equation 1 below. The scheme defined in Equation 1 below is only an example provided according to a particular embodiment of the present invention, and thus cryptographic methods other than the scheme defined in Equation 1 below may be used to verify whether the extracted EMID (ID_i for 1≦i≦N) coincides with the signature on the ID, in accordance with embodiments of the present invention.

Verify_RSA(hash(ID_i), additional parameter)=Value of Signature on ID for all i(1≦i≦N) (1)

When at least one of ‘N’ values is successfully verified in step 740, the recording device 430 confirms physical identification. In step 750, the recording device 430 generates an extracted and verified ID and a BoundEncryptionKey of the content. In this case, a binding technology as defined in Equation 2 below may be used. However the scheme defined in Equation 2 below is only an embodiment of the present invention, and thus a cryptographic method other than the scheme defined in Equation 2 below may be used, in accordance with embodiments of the present invention.

hash(ID, ContentsID, ContentsEncryptionKey, additional Information)=BoundEncryptionKey (2)

In step 760, the recording device 430 first encrypts the content by using a BoundEncryptionKey, and then a ContentsEncryptionKey and the encrypted content are safely delivered to the storage device.

Meanwhile, the authentication of the storage device 310 in steps 710 to 770 may be repeatedly performed a preset number of times before or during recording.

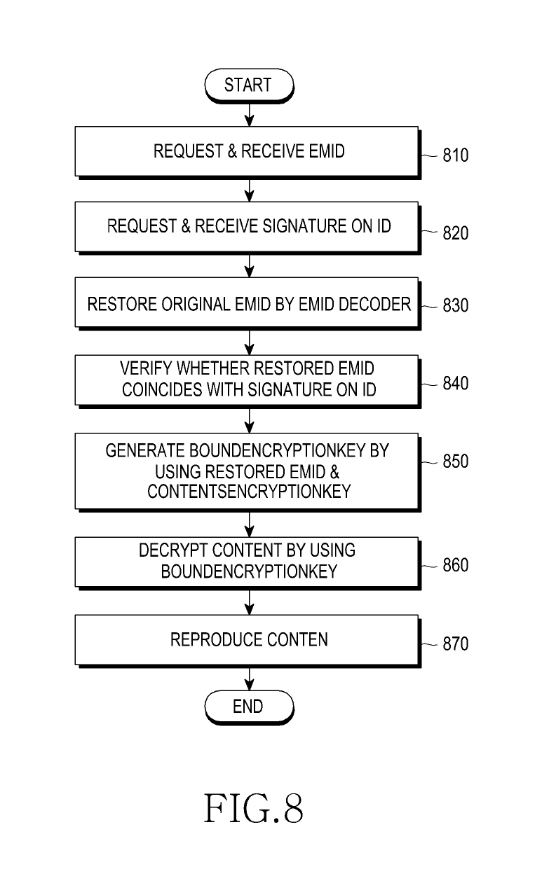

FIG. 8 is a flowchart illustrating a method for reproducing content recorded in a storage device according to an embodiment of the present invention.

Referring to FIG. 8, in step 810, the reproduction device 430 (i.e. an authentication apparatus 330) sends a request to the storage device 310 for changed EMIDs, and receives the requested changed EMIDs from the storage device 310. At this time, the received changed EMIDs have multiple values (e.g., EMID_1, EMID_2, . . . , EMID_N), respectively, obtained in such a manner that a value stored in the EMID area 312 of the storage device 310 first goes through the EMID encoder 318 and then noise is added to the value by the EMID encoder 318.

In step 820, the reproduction device 430 sends a request to the storage device 310 for a signature on the ID, an encrypted code parameter, etc., which are necessary to verify the storage device 310, and receives the requested signature, encrypted code parameter, etc., from the storage device 310.

In step 830, the reproduction device 430 provides the multiple values received in step 810 to the EMID decoder 330. The EMID decoder 330 applies a decoding process to the multiple received values (EMID_i for 1≦i≦N), and then extracts the original ID (i.e. ID_i for 1≦i≦N).

In the present example, the reproduction device 430 may restore the original ID from the multiple EMIDs provided in one round EID.

In step 840, a typical RSA cryptosystem verifies whether the extracted EMID (ID_i for 1≦i≦N) coincides with a signature on the ID, as defined in Equation 3 below.

The scheme defined in Equation 3 below is only an example provided according to a particular embodiment of the present invention, and thus cryptographic methods other than the scheme defined in Equation 3 below may be used to verify whether the extracted EMID (ID_i for 1≦i≦N) coincides with the signature on the ID, in accordance with embodiments of the present invention.

RSA_Signature_verify(Public_key_LicenseAuthority, ID_i)=Value of Signature on ID for all i (1≦i≦N) (3)

When at least one of ‘N’ EMID values is successfully verified in step 840, the reproduction device 430 determines that the storage device 310 is a legitimate storage medium. In step 850, the reproduction device 430 generates a BoundEncryptionKey by using an extracted and verified EMID and a ContentsEncryptionKey, as defined in Equation 4 below.

hash(ID, ContentsID, ContentsEncryptionKey, additional Information)=BoundEncryptionKey (4)

In step 860, the reproduction device 430 decrypts the content by using a BoundEncryptionKey, and reproduces the content in step 870.

Meanwhile, the authentication operation of steps 810 to 870 may be repeatedly performed a preset number of times according to the strength of security required before or during performing of reproduction.

If the verification in step 840 fails, the reproduction device 430 may stop the reproduction of the content, connect to a prepared license authority site, etc. to transmit the reason for discarding the relevant storage device, and then request discarding of the storage device.

When device authentication is performed for a physical property of the storage medium, through the operation, in which the reproduction or recording device obtains encoded ID information, into which noise generated by the non-volatile memory device itself has been inserted, and the encoded ID information including the noise is restored to the original physical identifier by the ID decoder device, embodiments of the present invention provide protection technology that is robust against attacks in which an unauthorized entity pretends to be a storage medium having legitimate content.

When a storage medium is determined to be illegitimate through the authentication process of distinguishing between a legitimate storage medium and an illegally manufactured storage medium according to embodiments of the present invention, a connection is made to a previously established license authority site, etc., in order to transmit the reason for discarding the storage medium, and then a request for discarding the illegitimate storage medium is sent, in order to exclude the illegitimate storage medium.

The operation and the configuration may be implemented as described above in the method and the apparatus for authenticating a non-volatile memory device according to an embodiment of the present invention.

While the invention has been shown and described with reference to certain embodiments thereof, it will be understood by those skilled in the art that various changes in form and details may be made therein without departing from the spirit and scope of the invention. Therefore, the spirit and scope of the present invention is not limited to the described embodiments thereof, but is defined by the appended claims and equivalents thereof.

What is claimed is:

1. A method for authenticating a non-volatile memory device, the method comprising:
sending, to the memory device, a request for an Enhanced Media Identification (EMID) for identifying the memory device, by an EMID decoder for authenticating the memory device;
receiving the requested EMID changed by a preset calculation of the EMID with an optional value from the memory device; and
restoring the EMID by decoding the received changed EMID.

2. The method of claim 1, wherein the changed EMID corresponds to an EMID changed by the preset calculation of the EMID with a random error generated by the memory device, unique information included in the EMID and a value for EMID encoding received from the EMID decoder for authenticating the memory device.

3. The method of claim 1, wherein, in receiving the requested changed EMID from the memory device, multiple requested EMIDs changed by the preset calculation of the multiple EMIDs with the optional value are received from the memory device.

4. The method of claim 1, further comprising verifying the restored EMID by using a signature corresponding to the identification received from the memory device.

5. The method of claim 4, further comprising:
generating a bound encryption key of content to be recorded in the memory device by binding the content to the restored and verified EMID; and
encrypting the content to be recorded by using the bound encryption key.

6. The method of claim 4, further comprising:
generating a bound encryption key by using both the restored and verified EMID and an encryption key of content to be reproduced in the memory device; and
decrypting the content by using the bound encryption key.

7. The method of claim 1, wherein restoring the EMID by decoding the received changed EMID comprises:
sending, to the memory device, a request for a signature corresponding to the identification and parameter information for decoding the EMID, by the EMID decoder for authenticating the memory device;
receiving the requested signature and the requested parameter information from the memory device, by the EMID decoder for authenticating the memory device; and
restoring the EMID by decoding the changed EMID by using the received parameter information.

8. An Enhanced Media Identification (EMID) decoder for authenticating a non-volatile memory device, the EMID decoder comprising:
a medium authenticator for sending, to the memory device, a request for an EMID for identifying the memory device, receiving the requested EMID changed by a preset calculation of the EMID with an optional value, and delivering the received changed EMID to an EMID restoration unit; and
the EMID restoration unit for restoring the EMID by decoding the received changed EMID.

9. The EMID decoder of claim 8, wherein the EMID changed by the preset calculation of the EMID with the optional value corresponds to an EMID changed by the preset calculation of the EMID with a random error generated by the memory device, unique information included in the EMID and a value for EMID encoding received from the EMID decoder for authenticating the memory device.

10. The EMID decoder of claim 8, wherein, when the medium authenticator receives the requested changed EMID, the medium authenticator receives multiple requested EMIDs changed by the preset calculation of the multiple EMIDs with the optional value from the memory device.

11. The EMID decoder of claim 8, wherein the medium authenticator verifies the restored EMID by using a signature corresponding to the identification received from the memory device.

12. The EMID decoder of claim 11, wherein, when content is recorded in the memory device, the medium authenticator generates a bound encryption key of the content by binding the content to the restored and verified EMID, and encrypts the content to be recorded by using the bound encryption key.

13. The EMID decoder of claim 11, wherein, when content recorded in the memory device is reproduced, the medium authenticator generates a bound encryption key by using both the restored and verified EMID and an encryption key of content to be reproduced in the memory device, and decrypts the content by using the bound encryption key.

14. The EMID decoder of claim 8, wherein the medium authenticator sends, to the memory device, a request for a signature corresponding to the identification and parameter information for decoding the EMID, and receives the requested signature and the requested parameter information from the memory device; and
wherein the EMID restoration unit restores the EMID by decoding the changed EMID by using the received parameter information.
